(19) United States
(12) Patent Application Publication
(10) Pub. No.: US 2026/0063508 A1
(43) Pub. Date: Mar. 5, 2026

(54) APPARATUS FOR GENERATING GROUP VELOCITY DISPERSION AND QUANTUM COMMUNICATION SYSTEM USING THE SAME

(71) Applicant: POSTECH RESEARCH AND BUSINESS DEVELOPMENT FOUNDATION, Pohang-si (KR)

(72) Inventors: Yoon-Ho KIM, Pohang-si (KR); Heebong SEO, Pohang-si (KR); Jin-Woo CHAE, Pohang-si (KR)

(73) Assignee: POSTECH RESEARCH AND BUSINESS DEVELOPMENT FOUNDATION, Pohang-si (KR)

(21) Appl. No.: 19/264,727

(22) Filed: Jul. 9, 2025

(30) Foreign Application Priority Data
Aug. 30, 2024 (KR) 10-2024-0117272
Dec. 23, 2024 (KR) 10-2024-0193483

(51) Int. Cl. G01M 11/00; H04B 10/70

(52) U.S. Cl. CPC G01M 11/338; H04B 10/70

(57) ABSTRACT

An apparatus for generating group velocity dispersion comprising: a group velocity dispersion module composed of an optical fiber, the group velocity dispersion module applying group velocity dispersion to at least one channel signal in which information is encoded to adjust a time difference between adjacent two channel signals; and a controller configured to receive optical fiber length information and control the group velocity dispersion module based on the optical fiber length information, wherein the group velocity dispersion module includes: a group velocity dispersion generation line connected to the input line, separating the input quantum signal into a plurality of channel signals in which information is encoded using a plurality of filters, and generating group velocity dispersion according to a line length difference for each channel signal passing through each channel line to adjust a time difference between the channel signals.

### CROSS-REFERENCE TO RELATED APPLICATION

This application claims priority under 35 U.S.C § 119 to Korean Patent Application No. 10-2024-0117272 filed on Aug. 30, 2024, and Korean Patent Application No. 10-2024-0193483 filed on Dec. 23, 2024, in the Korean Intellectual Property Office, the entire contents of which are hereby incorporated by reference.

### TECHNICAL FIELD

The disclosure relates to an apparatus for generating group velocity dispersion and a quantum communication system using the same.

### BACKGROUND

The content described in this section simply provides background information for the embodiment and does not constitute the prior art.

Group velocity dispersion (GVD) is a phenomenon that occurs due to the change in group velocity of light depending on the wavelength while passing through a dispersive medium. It is one of the important phenomena that mainly appear in optics. This distorts the temporal characteristics of optical signals and is considered a factor that interferes with information transmission in classical communication. However, in quantum communication, group velocity dispersion may be utilized as an important parameter in a quantum communication protocol.

An apparatus for generating group velocity dispersion, mainly used in classical communication, consists of a dispersive medium that generates group velocity dispersion, such as an optical fiber, and an amplifier that compensates for an optical loss occurring when passing through the dispersive medium. By repeatedly passing through the apparatus until a desired amount of group velocity dispersion is generated, it is possible to generate the desired amount of group velocity dispersion without being limited by the optical loss.

However, in quantum communication, the use of an amplifier is impossible due to the no-cloning theorem, and thus only methods utilizing conventional dispersive media as they exist. Dispersive media mainly used include optical fibers and diffraction gratings. An optical fiber may generate group velocity dispersion through a dispersion coefficient of the optical fiber, and a diffraction grating may generate group velocity dispersion through differences in path lengths between signals separated by wavelength due to the optical grating having a periodic structure.

First, when using an optical fiber, the amount of group velocity dispersion generated by the optical fiber increases in proportion to the length of the optical fiber, so a long optical fiber is required to generate a large amount of group velocity dispersion. However, since optical fibers in a communication wavelength band typically cause an optical loss of 0.2 dB/km, when generating a large amount of group velocity dispersion, there is a problem that the number of photons transmitted through the optical fiber decreases due to the large optical loss. Moreover, in long-distance quantum communication, since high optical loss already occurs while passing through a long communication channel, when using an optical fiber as a dispersive medium, the amount of group velocity dispersion that can be generated is further reduced.

Second, when using a diffraction grating, group velocity dispersion is generated through a path length difference between optical signals separated by wavelength in free space. However, since the speed of light is very fast, the temporal separation between optical signals of different wavelengths is very small. As a result, when using a diffraction grating, it is difficult to generate a large amount of group velocity dispersion due to the characteristics of the dispersive medium.

Therefore, when using conventional dispersive media, it is difficult to achieve the desired level of group velocity dispersion, making long-distance quantum communication susceptible to the effects of group velocity dispersion. Accordingly, in the field of quantum communication, the need for a new apparatus capable of effectively controlling group velocity dispersion is emerging in order to implement various quantum communication protocols that use group velocity dispersion as a parameter.

The present application was made based on the research results of Individual Basic Research Project of the National Research Foundation of Korea in the Ministry of Science and ICT (2710000543), Information and Communications Broadcasting Innovation Talent Development (R&D) Project of the Institute for Information & Communications Technology Planning & Evaluation in the Ministry of Science and ICT (2710081644).

The description set forth in the background section should not be assumed to be prior art merely because it is set forth in the background section. The background section may describe aspects or embodiments of the disclosure.

### SUMMARY

An aspect of the disclosure is to provide an apparatus for generating group velocity dispersion (GVD), which generates group velocity dispersion based on a path length difference for signals passing through each dense wavelength-division multiplexing (DWDM) filter by using a wavelength-division multiplexing technique, and a quantum communication system using the same.

According to some aspects of the disclosure, An apparatus for generating group velocity dispersion that generates group velocity dispersion for a quantum signal, comprising: a group velocity dispersion module composed of an optical fiber, the group velocity dispersion module applying group velocity dispersion to at least one channel signal in which information is encoded to adjust a time difference between adjacent two channel signals; and a controller configured to receive optical fiber length information and control the group velocity dispersion module based on the optical fiber length information, wherein the group velocity dispersion module includes: an input line into which the quantum signal is input; a group velocity dispersion generation line connected to the input line, separating the input quantum signal into a plurality of channel signals in which information is encoded using a plurality of filters, and generating group velocity dispersion according to a line length difference for each channel signal passing through each channel line to adjust a time difference between the channel signals; and an output line that outputs each channel signal.

According to some aspects, the group velocity dispersion generation line includes: a first channel line that separates a first channel signal having the longest wavelength from the quantum signal; and at least one second channel line that separates a second channel signal, which is not the first channel signal, from the quantum signal and generates the group velocity dispersion to delay the second channel signal by a predetermined time.

According to some aspects, the first channel line includes: a first filter that separates the first channel signal from the quantum signal.

According to some aspects, the second channel line includes: a second filter that extracts the second channel signal from the quantum signal; a variable delay line (VDL) that corrects a time difference between the second channel signal output from the second filter and a preceding channel signal to a first delay time; and a delay line that generates a second delay time in a time difference between the second channel signal and the preceding channel signal after passing through the variable delay line.

According to some aspects, the delay line is an extended section formed through fusion splicing, and the second channel line is longer than the first channel line by a length corresponding to the delay line.

According to some aspects, the delay line is formed to have a length that generates the second delay time for the second channel signal based on the wavelength of the second channel signal.

According to some aspects, the controller calculates an adjusted delay time between adjacent two channel signals according to the optical fiber length information based on group velocity dispersion data, and adjusts a delay time between adjacent two channel signals to the first delay time by controlling the variable delay line based on the adjusted delay time; and wherein the group velocity dispersion data includes: information on the adjusted delay time according to the optical fiber length information and the channel signal information.

According to some aspects, the controller controls the variable delay line to correct a delay time of the second channel signal to the first delay time, which is a difference between the adjusted delay time and the second delay time.

According to some aspects, the first channel line and the second channel line are connected in parallel to the input line.

According to some aspects of the disclosure, A quantum communication system, comprising: a transmitter that generates a quantum signal; a receiver that receives the quantum signal; a quantum channel provided as an optical fiber through which the quantum signal moves; and an apparatus for generating group velocity dispersion coupled to the transmitter and configured to generate group velocity dispersion for the quantum signal based on a length of the quantum channel to adjust arrival times of each channel signal included in the quantum signal.

Aspects of the disclosure are not limited to those mentioned above and other objects and advantages of the disclosure that have not been mentioned can be understood by the following description and will be more clearly understood according to embodiments of the disclosure. In addition, it will be readily understood that the objects and advantages of the disclosure can be realized by the means and combinations thereof set forth in the claims.

Aspects of the disclosure are not limited to those mentioned above and other objects and advantages of the disclosure that have not been mentioned can be understood by the following description and will be more clearly understood according to embodiments of the disclosure. In addition, it will be readily understood that the objects and advantages of the disclosure can be realized by the means and combinations thereof set forth in the claims.

The apparatus for generating group velocity dispersion of the disclosure and a quantum communication system including the same may generate group velocity dispersion having desired characteristics while causing only a minimal optical loss (up to 2 dB) by adjusting a constant path length difference between adjacent channel signals.

In addition, since a large amount of group velocity dispersion that was impossible to generate due to a limitation in the optical loss may be generated, it becomes possible to implement various quantum communication protocols that have been proposed only theoretically and use group velocity dispersion as a parameter.

Moreover, in the field of photon-based quantum computing, it is possible to achieve more accurate information processing by compensating for signal distortion caused by group velocity dispersion during data transmission, and furthermore, by utilizing continuous variables having infinite dimensionality instead of quantum bits (qubits) having conventional two-dimensional states, d-dimensional quantum bits (qudits) having d-dimensional states may be utilized to provide greater information capacity and enhanced computational capability.

Additionally, as the digitization of sensitive information such as finance, healthcare, and military fields progresses, in the modern information era where secure transmission and storage of data are essential, the apparatus for generating group velocity dispersion may contribute to providing enhanced security in the field of information and communication security, such as in quantum cryptography systems of mobile communication operators utilizing quantum key distribution (QKD) systems to overcome vulnerabilities of modern security systems threatened by the improvement of computing capabilities.

In addition to the above, the specific effects of the disclosure will be described together with the detailed description for implementing the disclosure.

### BRIEF DESCRIPTION OF THE DRAWINGS

FIG. 1 is a conceptual diagram schematically illustrating an apparatus for generating group velocity dispersion according to an embodiment of the disclosure.

FIG. 2 is a conceptual diagram schematically illustrating a configuration of a group velocity dispersion module shown in FIG. 1.

FIG. 3 is a graph showing the coincidence count measurement results depending on whether the apparatus for generating group velocity dispersion is applied.

FIG. 4 is a conceptual diagram schematically illustrating a quantum communication system according to an embodiment of the disclosure.

### DETAILED DESCRIPTION OF THE PREFERRED EMBODIMENTS

The terms or words used in the disclosure and the claims should not be construed as limited to their ordinary or lexical meanings. They should be construed as the meaning and concept in line with the technical idea of the disclosure based on the principle that the inventor can define the concept of terms or words in order to describe his/her own inventive concept in the best possible way. Further, since the embodiment described herein and the configurations illustrated in the drawings are merely one embodiment in which the disclosure is realized and do not represent all the technical ideas of the disclosure, it should be understood that there may be various equivalents, variations, and applicable examples that can replace them at the time of filing this application.

Although terms such as first, second, A, B, etc., used in the description and the claims may be used to describe various components, the components should not be limited by these terms. These terms are only used to differentiate one component from another. For example, a first component may be referred to as a second component, and similarly, a second component may be referred to as a first component, without departing from the scope of the disclosure. The term ‘and/or’ includes a combination of a plurality of related listed items or any item of the plurality of related listed items.

The terms used in the description and the claims are merely used to describe particular embodiments and are not intended to limit the disclosure. Singular forms are intended to include plural forms unless the context clearly indicates otherwise. In the application, terms such as “comprise,” “have,” etc., should be understood as not precluding the possibility of existence or addition of features, numbers, steps, operations, components, parts, or combinations thereof described herein.

Unless otherwise defined, the phrases “A, B, or C,” “at least one of A, B, or C,” or “at least one of A, B, and C” may refer to only A, only B, only C, both A and B, both A and C, both B and C, all of A, B, and C, or any combination thereof.

Unless being defined otherwise, all terms used herein, including technical or scientific terms, have the same meaning as commonly understood by those skilled in the art to which the disclosure pertains.

Terms such as those defined in commonly used dictionaries should be construed as having a meaning consistent with the meaning in the context of the relevant art, and are not to be construed in an ideal or excessively formal sense unless explicitly defined in the application. In addition, each configuration, procedure, process, method, or the like included in each embodiment of the disclosure may be shared to the extent that they are not technically contradictory to each other.

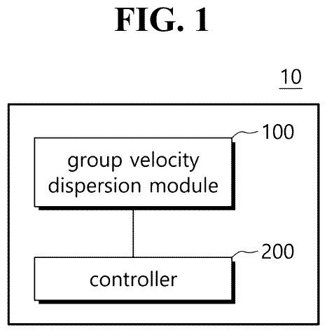

Hereinafter, with reference to FIGS. 1 to 4, an apparatus for generating group velocity dispersion (GVD) and a quantum communication system including the same according to embodiments of the disclosure will be described in detail.

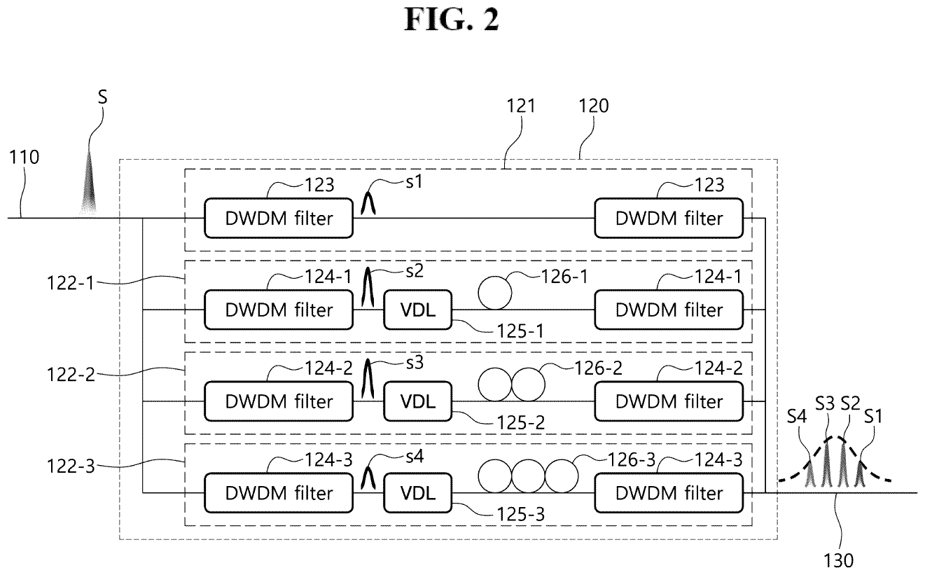

FIG. 1 is a conceptual diagram schematically illustrating an apparatus for generating group velocity dispersion according to an embodiment of the disclosure, and FIG. 2 is a conceptual diagram schematically illustrating a configuration of a group velocity dispersion module shown in FIG. 1.

The apparatus for generating group velocity dispersion will be described with reference to FIGS. 1 and 2.

Referring to FIG. 1, an apparatus for generating group velocity dispersion 10 may include a group velocity dispersion module 100 and a controller 200.

The group velocity dispersion module 100 is composed of an optical fiber and may generate group velocity dispersion according to a line length difference for at least one channel signal in which information is encoded to adjust a delay time between each channel signal. The controller 200 may receive optical fiber length information and may control the group velocity dispersion module 100 to generate group velocity dispersion corresponding to the optical fiber length information. The group velocity dispersion module 100 will be described with reference to FIG. 2. The group velocity dispersion module 100 may include an input line 110 through which a quantum signal S generated from a signal generator is input, a group velocity dispersion generation line 120 that generates group velocity dispersion for the quantum signal S according to a line length difference, and an output line 130 that outputs each channel signal of the quantum signal S.

The group velocity dispersion generation line 120 is connected to the input line 110 and may adjust a delay time of at least one channel signal by generating group velocity dispersion according to a line length difference. The group velocity dispersion generation line 120 may include a first channel line 121 and at least one second channel line 122. The first channel line 121 and the second channel line 122 are connected in parallel to the input line 110, so that the quantum signal may be input into the first channel line 121 and the second channel line 122, respectively.

The first channel line 121 may separate a first channel signal having the longest wavelength from the quantum signal. The first channel signal serves as a reference signal, and delay times of the respective channel lines may be adjusted based on the first channel signal.

The first channel line 121 may include a first filter 123. The first filter 123 may extract a first channel signal in a first wavelength band from the quantum signal. The first channel line 121 may include a first filter 123 at each of an input end 121a into which a quantum signal is input and an output end 121b from which the quantum signal is output. The first filter 123 provided at the input end 121a may perform an operation of separating a first wavelength band from the quantum signal to generate a first channel signal, and the first filter 123 provided at the output end 121b may perform wavelength-division multiplexing to combine the first channel signal into the same output line as a subsequent channel signal. In this case, the first filter 123 may be provided as a dense wavelength-division multiplexing (DWDM) filter, but is not limited thereto, and any filter capable of extracting or separating a predetermined channel signal from the quantum signal S may be applicable. To briefly describe the dense wavelength-division multiplexing filter, the dense wavelength-division multiplexing filter is an optical filter that selectively filters wavelengths. The quantum signal S includes multiple wavelengths (for example, 1549.32 nm, 1550.12 nm, 1550.92 nm, etc.), and the dense wavelength-division multiplexing filter may separate a desired wavelength by selectively transmitting or reflecting a specific wavelength among them.

The second channel line 122 may separate a second channel signal, which is not the first channel signal, among a plurality of channel signals of the quantum signal, and may generate group velocity dispersion to adjust a delay time relative to a previous channel signal.

The second channel line 122 may include a second filter 124, a variable delay line (VDL) 125, and a delay line 126. The second filter 124 may separate a second channel signal having a predetermined wavelength from the quantum signal, and the variable delay line 125 may apply a first delay time to the second channel signal. In this case, the variable delay line 125 may generate the first delay time with an accuracy of several picoseconds and up to 500 picoseconds. In addition, the delay line 126 may generate a second delay time for the second channel signal. That is, the second channel signal passing through the second channel line 122 may arrive at a receiving device later than a previous channel signal by a time corresponding to a sum of the first delay time and the second delay time.

In this case, the second filter 124 may also be provided as a dense wavelength-division multiplexing filter, but is not limited thereto, and any filter capable of extracting or separating a predetermined channel signal from the quantum signal S may be applicable. The variable delay line 125 is a device that adjusts a delay time of a channel signal with an accuracy of several picoseconds, and the variable delay line 125 may adjust a delay time between different channel signals with an accuracy of several picoseconds and up to 500 picoseconds. The delay line 126 is an extended section formed through fusion splicing and may be formed to have a length capable of generating the second delay time for the second channel signal based on the wavelength of the second channel signal. Accordingly, the second channel line 122 may also include a second filter 124 at each of the input end and the output end, like the first channel line 121, to implement a wavelength-division multiplexing technique.

Next, the operation of the controller 200 will be described. The controller 200 may calculate an adjusted delay time between two adjacent channel signals according to optical fiber length information based on group velocity dispersion data, and may adjust the delay time of the second channel signal to a desired delay time by controlling the variable delay line 125 based on the adjusted delay time with an accuracy of several picoseconds.

For example, the controller 200 may calculate an adjusted delay time between each channel signal based on preset wavelength information of the first and second channel signals, the optical fiber length, and group velocity dispersion data. Then, the delay time of the second channel signal is adjusted by controlling the variable delay line 125 with a first delay time obtained by subtracting the second delay time generated by the delay line 126 from the calculated adjusted delay time. The second channel signal that has passed through the variable delay line 125 may have a second delay time added by the delay line 126, and may finally arrive at a receiving device later than the first channel signal by a time corresponding to the sum of the first delay time and the second delay time.

As such, since the second delay time generated by the delay line 126 included in the second channel line 122 is fixed, the controller 200 may generate group velocity dispersion for the corresponding optical fiber with an accuracy of several picoseconds by controlling the variable delay line 125 based on the optical fiber length.

With reference to FIG. 2, in a case where a plurality of channel signals of a quantum signal are configured as CH14, CH19, CH24, and CH29 based on the telecom C-band 100 GHz dense wavelength-division multiplexing ITU grid, the operation of the group velocity dispersion generation line 120 including one first channel line 121 and three second channel lines 122 will be described as an example.

The first channel line 121 may separate a first channel signal s1 corresponding to CH14 having the longest wavelength, the second-1 channel line 122-1 may separate a second channel signal s2 corresponding to CH19 having a shorter wavelength than the first channel signal, the second-2 channel line 122-2 may separate a third channel signal s3 corresponding to CH24 having a shorter wavelength than the second channel signal, and the second-3 channel line 122-3 may separate a fourth channel signal s4 corresponding to CH29 having a shorter wavelength than the third channel signal. That is, the wavelength may become shorter from the first channel signal s1 to the fourth channel signal s4. In addition, a wavelength difference between each channel signal may be the same.

Each variable delay line 125 of the respective second channel lines 122 adjusts a first delay time between a corresponding channel signal and a preceding channel signal. That is, a first variable delay line 125-1 adjusts a delay time between the first channel signal s1 and the second channel signal s2 to the first delay time, a second variable delay line 125-2 adjusts a delay time between the second channel signal s2 and the third channel signal s3 to the first delay time, and a third variable delay line 125-3 adjusts a delay time between the third channel signal s3 and the fourth channel signal s4 to the first delay time. In this case, each variable delay line 125 may adjust the first delay time with an accuracy of several picoseconds.

In addition, each delay line 126 of the respective second channel lines 122 may generate a second delay time corresponding to a time difference between the corresponding channel signal and a preceding channel signal. That is, the first delay line 126-1 may add a second delay time to a time difference between the first channel signal s1 and the second channel signal s2, the second delay line 126-2 may add a second delay time to a time difference between the second channel signal s2 and the third channel signal s3, and the third delay line 126-3 may add a second delay time to a time difference between the third channel signal s3 and the fourth channel signal s4.

Again, describing this based on the first channel signal s1, the second channel signal s2 may have a second delay time added to a time difference with the first channel signal s1 through the first delay line 126-1 with an accuracy of several hundred picoseconds, the third channel signal s3 may have twice the second delay time added to a time difference with the first channel signal s1 through the second delay line 126-2 with an accuracy of several hundred picoseconds, and the fourth channel signal s4 may have three times the second delay time added to a time difference with the first channel signal s1 through the third delay line 126-3 with an accuracy of several hundred picoseconds.

That is, if the second delay time is 25 nanoseconds, the first delay line 126-1 may be formed to have a length corresponding to a delay of 25 nanoseconds compared to the first channel signal s1, the second delay line 126-2 may be formed to have a length corresponding to a delay of 50 nanoseconds compared to the first channel signal s1, and the third delay line 126-3 may be formed to have a length corresponding to a delay of 75 nanoseconds compared to the first channel signal s1.

Accordingly, the second-1 channel line 122-1 is formed to be longer than the first channel line 121 by a length corresponding to the first delay line 126-1, the second-2 channel line 122-2 is formed to be longer than the second-1 channel line 122-1 by a length corresponding to the second delay line 126-2, and the second-3 channel line 122-3 is formed to be longer than the second-2 channel line 122-2 by a length corresponding to the third delay line 126-3.

In addition, since the second delay time is cumulatively added with respect to the previous channel signal as the wavelength of the corresponding channel signal becomes shorter, the second delay line 126-2 may be longer than the first delay line 126-1, and the third delay line 126-3 may be longer than the second delay line 126-2.

That is, by adjusting a delay time between adjacent two channel signals, it is possible to output the channel signals from the output line 130 in the order of longer wavelengths, so that they may sequentially arrive in the order of longer wavelengths. At this time, the delay time difference between each channel signal may be adjusted to be the same, and group velocity dispersion corresponding to the optical fiber length may eventually be maintained.

The controller 200 may calculate an adjusted delay time between each channel signal based on the length of the optical fiber, channel signal information of the quantum signal, and group velocity dispersion data. The controller 200 may set a first delay time by controlling the variable delay line 125 of each second channel line 122.

The controller 200 may set each variable delay line 125 to the first delay time obtained by subtracting a second delay time added by the delay line 126 from the adjusted delay time.

As described above, since a second delay time added to a time difference between previous channel lines by the delay line 126 included in each second channel line 122 is fixed, it is possible to adjust a time difference between a corresponding second channel signal and a previous channel signal to a first delay time through the variable delay line 125, thereby generating group velocity dispersion based on an optical fiber length with an accuracy of several picoseconds and applying it to a quantum signal.

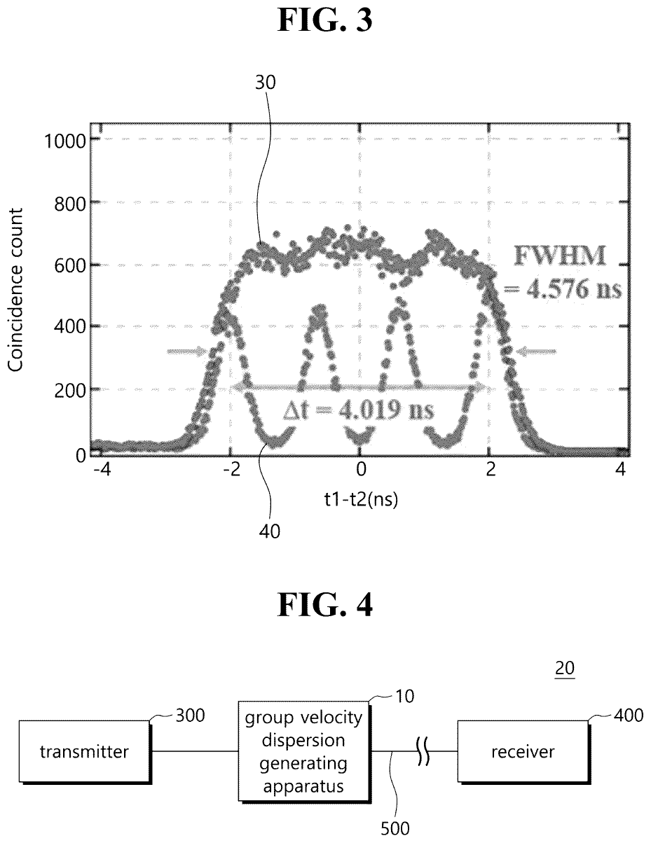

FIG. 3 is a graph showing group velocity dispersion for CH14, CH19, CH24, and CH29 for an optical fiber of 20.3 km.

Referring to FIG. 3, a first graph 30 is a result of measuring coincidence counts obtained by using only the optical fiber of 20.3 km without using the apparatus for generating group velocity dispersion 10, and a second graph 40 is a result of measuring coincidence counts obtained by using the apparatus for generating group velocity dispersion 10.

As such, when a time difference between adjacent two channel signals is uniformly formed, and a time difference between the two farthest channel signals, CH14 and CH29, is set to 4.019 nanoseconds, it is possible to substantially generate group velocity dispersion corresponding to the 20.3 km optical fiber while minimizing optical loss.

FIG. 4 is a block diagram schematically illustrating a quantum communication system according to an embodiment of the disclosure.

Referring to FIG. 4, a quantum communication system 20 may include a transmitter 300, a receiver 400, a quantum channel 500, and the apparatus for generating group velocity dispersion 10.

The transmitter 300 generates a quantum signal, the receiver 400 receives the quantum signal, and the quantum channel 500 is provided as an optical fiber through which the quantum signal moves.

The apparatus for generating group velocity dispersion 10 is coupled to the transmitter 300 and may generate group velocity dispersion for the quantum signal based on the length of the quantum channel 500 to adjust arrival times of each channel signal included in the quantum signal.

Since the configuration of the apparatus for generating group velocity dispersion 10 corresponds to the apparatus for generating group velocity dispersion 10 described with reference to FIGS. 1 and 2, a detailed description thereof will be omitted.

The quantum communication system 20, including such the apparatus for generating group velocity dispersion 10, may implement various quantum communication protocols that use group velocity dispersion as a parameter, which are difficult to implement with conventional dispersive media.

Various quantum communication protocols that use group velocity dispersion as a parameter proceed with quantum communication by controlling group velocity dispersion using dispersive media having various characteristics.

For example, in the case of nonlocal dispersion cancellation, dispersive media having the same amount of group velocity dispersion that can be generated by an optical fiber of 300 km or more but having opposite signs are installed on respective paths through which each photon of a photon pair passes, and energy-time quantum entanglement is verified by measuring the time correlation between the photon pair, then symmetrically exchanging the locations of the dispersive media installed on the two paths, and measuring the time correlation again.

However, since the dispersion coefficients of conventional dispersive media such as optical fibers have wavelength dependence, when the wavelength band of an optical signal passing through the dispersive medium changes, the amount of group velocity dispersion also changes. As a result, when the locations of the dispersive media in the two paths are exchanged, if the wavelength bands of the optical signals passing through both paths are different, there arises a problem in that the amounts of group velocity dispersion in the two paths also become different.

However, in the case of the quantum communication system 20 including the apparatus for generating group velocity dispersion 10 using a wavelength-division multiplexing technique according to the disclosure, a constant amount of group velocity dispersion may be generated through a constant path length difference between adjacent channel signals, and since there is no wavelength dependence, if devices having the same path length difference but in opposite directions are constructed, it is possible to easily satisfy the complex conditions of dispersive media required by nonlocal dispersion cancellation quantum communication protocols.

As such, since the quantum communication system 20 of the disclosure can directly and easily fabricate group velocity dispersion having desired characteristics, it is possible to implement various quantum communication protocols that use group velocity dispersion as a parameter, which are difficult to implement with conventional dispersive media.

The above description is merely an illustrative example of the technical ideas of the embodiments, and those having ordinary knowledge in the technical field to which the embodiments pertain will be able to make various modifications and variations without departing from the essential characteristics of the embodiment. Therefore, the embodiments are intended not to limit but to describe the technical ideas of the embodiments, and the scope of the technical ideas of the embodiments is not limited by these embodiments. The scope of protection of the embodiments should be construed in accordance with the claims below, and all technical ideas within the scope equivalent thereto should be construed as falling within the scope of rights of the embodiments.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims. It is therefore desired that the embodiments be considered in all respects as illustrative and not restrictive, reference being made to the appended claims rather than the foregoing description to indicate the scope of the disclosure.

What is claimed is:

1. An apparatus for generating group velocity dispersion (GVD) for a quantum signal, comprising:
a group velocity dispersion module composed of an optical fiber, the group velocity dispersion module applying group velocity dispersion to at least one channel signal in which information is encoded to adjust a time difference between adjacent two channel signals; and
a controller configured to receive optical fiber length information and control the group velocity dispersion module based on the optical fiber length information,
wherein the group velocity dispersion module includes:
an input line into which the quantum signal is input;
a group velocity dispersion generation line connected to the input line, separating the input quantum signal into a plurality of channel signals in which information is encoded using a plurality of filters, and generating group velocity dispersion according to a line length difference for each channel signal passing through each channel line to adjust a time difference between the channel signals; and
an output line that outputs each channel signal.

2. The apparatus for generating group velocity dispersion according to claim 1, wherein the group velocity dispersion generation line includes:
a first channel line that separates a first channel signal having the longest wavelength from the quantum signal; and
at least one second channel line that separates a second channel signal, which is not the first channel signal, from the quantum signal and generates the group velocity dispersion to delay the second channel signal by a predetermined time.

3. The apparatus for generating group velocity dispersion according to claim 2, wherein the first channel line includes:
a first filter that separates the first channel signal from the quantum signal.

4. The apparatus for generating group velocity dispersion according to claim 2, wherein the second channel line includes:
a second filter that extracts the second channel signal from the quantum signal;
a variable delay line (VDL) that corrects a time difference between the second channel signal output from the second filter and a preceding channel signal to a first delay time; and
a delay line that generates a second delay time in a time difference between the second channel signal and the preceding channel signal after passing through the variable delay line.

5. The apparatus for generating group velocity dispersion according to claim 4, wherein the delay line is an extended section formed through fusion splicing, and
the second channel line is longer than the first channel line by a length corresponding to the delay line.

6. The apparatus for generating group velocity dispersion according to claim 5, wherein the delay line is formed to have a length that generates the second delay time for the second channel signal based on a wavelength of the second channel signal.

7. The apparatus for generating group velocity dispersion according to claim 4, wherein the controller:
calculates an adjusted delay time between adjacent two channel signals according to the optical fiber length information based on group velocity dispersion data, and adjusts a delay time between adjacent two channel signals to the first delay time by controlling the variable delay line based on the adjusted delay time; and
wherein the group velocity dispersion data includes:
information on the adjusted delay time according to the optical fiber length information and the channel signal information.

8. The apparatus for generating group velocity dispersion according to claim 7, wherein the controller:
controls the variable delay line to correct a delay time of the second channel signal to the first delay time, which is a difference between the adjusted delay time and the second delay time.

9. The apparatus for generating group velocity dispersion according to claim 2, wherein the first channel line and the second channel line are connected in parallel to the input line.

10. A quantum communication system, comprising:
a transmitter that generates a quantum signal;
a receiver that receives the quantum signal;
a quantum channel provided as an optical fiber through which the quantum signal moves; and
an apparatus for generating group velocity dispersion coupled to the transmitter and configured to generate group velocity dispersion for the quantum signal based on a length of the quantum channel to adjust arrival times of each channel signal included in the quantum signal.
